(19) United States
(12) Patent Application Publication
(10) Pub. No.: US 2006/0021834 A1
(43) Pub. Date: Feb. 2, 2006

(54) Brake cam washer anti NVH

(76) Inventor: Dale Lee Kwasniewski, Galesburg, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/909,064

(22) Filed: Jul. 30, 2004

(51) Int. Cl. F16D 51/00

(52) U.S. Cl. 188/329

(57) ABSTRACT

An improved drum brake assembly is provided that reduces vibration and excessive movement of the cam washer by including at least one lug extending from a cam tube seal and at least one corresponding notch on a cam washer that positions the cam washer on the cam tube. By reducing vibration of the cam washer, wear of the components of the drum brake assembly is reduced. Reduction of vibration also serves to eliminate unpleasant noise during vehicle operation caused by the vibration. Reducing vibration of the cam washer also decreases contact of the cam washer with other metallic components and surfaces within the vehicle, which protects the cam washer from potential corrosion caused by such contact.

### BACKGROUND OF THE INVENTION

1. Field of the Invention

The present invention relates to a drum brake assembly, and more particularly, to an improved cam tube seal and cam washer.

2. Discussion of Related Art

A conventional drum brake assembly includes a shallow drum-shaped metal cylinder that attaches to the inner surface of the wheel of a vehicle and rotates with the wheel. When the brake pedal is pressed, brake shoes with brake linings press against the inner circumference of the drum to exert a braking effect upon the wheel to slow or stop the vehicle. Brake shoes are arc-shaped pieces activated by a cam on a cam shaft. The brake shoes are forced apart and bring the brake lining of the brake shoes into contact with the brake drum. The brake lining is typically a heat-resistant friction material attached to the brake shoe that grabs the interior of the brake drum to slow or stop the vehicle.

The rotating cam forces rollers radially outward, which then move the brake shoes into contact with the brake drum. The rollers convert the cam's rotary motion into linear motion. A camshaft rotates the cam and an air brake actuator rotates the camshaft, typically through a connection with a slack adjuster. In a conventional drum brake assembly, a cam washer is positioned between the cam and a cam tube from which the camshaft extends. The cam washer is loosely disposed about the camshaft and is provided to prevent the brake shoes from interfering with fasteners in a brake spider supporting various components of the brake.

Conventional drum brake assemblies have several drawbacks caused by the use of a loose-fit cam washer that may vibrate during vehicle operation. First, vibration of the cam washer contributes to increased wear of the components. Second, vibration may also emit unpleasant noise during vehicle operation. Third, vibration of the cam washer increases contact of the cam washer with other metallic components and surfaces within the vehicle, which is a source of corrosion.

The inventors herein have recognized a need for a brake drum assembly that will minimize and/or eliminate the above-identified deficiencies.

### SUMMARY OF THE INVENTION

The present invention provides a brake drum assembly for a vehicle. The brake drum assembly includes a cam tube disposed about an axis, a seal disposed proximate an outboard end of the cam tube, a cam shaft extending from the cam tube, a cam mounted to the cam shaft, and a cam washer disposed between the cam tube and cam. The brake drum assembly further includes first and second brake shoes configured for selective engagement with a drum surface in response to rotation of the cam. The seal includes a lug projecting therefrom, and the cam washer includes a notch configured to receive the lug.

A brake drum assembly in accordance with the present invention is advantageous as compared to existing brake drum assemblies. The inventive brake drum assembly prevents vibration of the cam washer and contact with other metal surfaces or components through the use of a lug and notch system on the cam tube and cam washer. By preventing vibration of the cam washer, wear on the drum brake assembly components is reduced and noise associated with the vibration is prevented. Furthermore, by isolating the cam washer from other metal components and surfaces, potential corrosion is reduced.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a plan view of a drum brake assembly in accordance with the present invention.

FIG. 2 is an exploded perspective view illustrating a portion of the drum brake assembly of FIG. 1.

FIG. 3 is a sectional view taken along lines 3-3 of FIG. 2.

### DETAILED DESCRIPTION OF EMBODIMENTS OF THE INVENTION

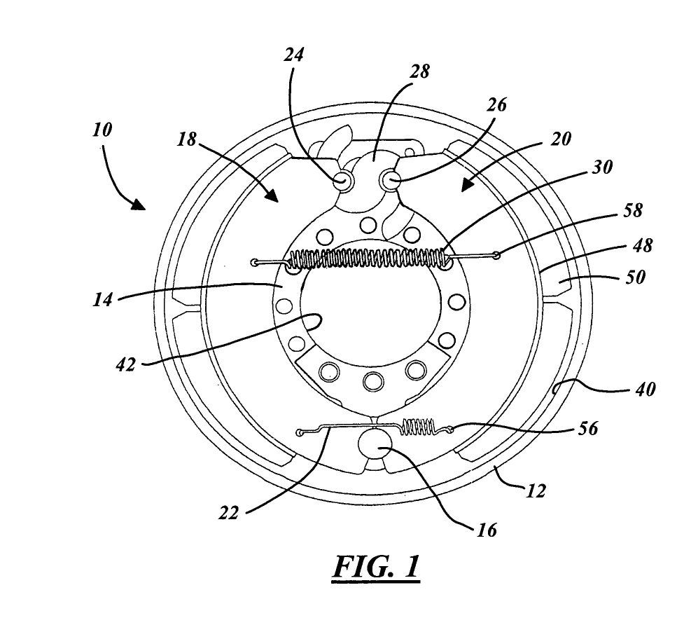

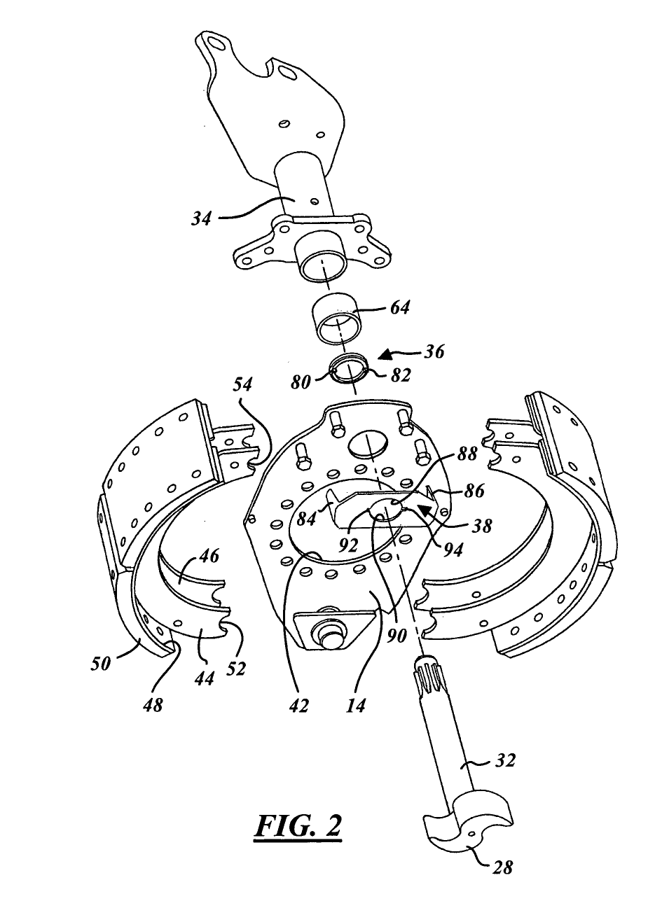

Referring now to the drawings wherein like reference numerals are used to identify identical components in the various views, FIG. 1 illustrates a drum brake assembly 10 in accordance with the present invention. Drum brake assembly 10 is provided to exert a braking effect upon a vehicle wheel to slow or stop the vehicle. Drum brake assembly may include a brake drum 12, a brake spider 14, an anchor 16, brake shoes 18, 20, retainer springs 22, cam followers 24, 26, cam 28, and return springs 30. Referring to FIG. 2, in accordance with the present invention, drum brake assembly 10 may also include a cam shaft 32, cam tube 34, a seal 36, and a cam washer 38.

Referring again to FIG. 1, brake drum 12 provides a braking surface 40 and is conventional in the art. Brake drum 12 may be made from conventional metals and metal alloys such as steel. Brake drum 12 is annular and rotates with the vehicle wheel or wheels at one end of an axle.

Brake spider 14 is provided to mount the various components of drum brake assembly 10 and is also conventional in the art. Spider 14 defines a central aperture 42 through which the vehicle axle may extend. Spider 14 also supports anchor 16 on one side of the axle and may further include an aperture on an opposite side of the axle through which a camshaft (not shown) supporting cam 28 extends.

Anchor 16 is provided to pivotally mount brake shoes 18, 20. Anchor 16 is conventional in the art and is supported on spider 14. Anchor 16 may comprise a round pin that extends axially from spider 14.

Brake shoes 18, 20 are provided for selective engagement with braking surface 32 of drum brake 12. Brake shoes 18, 20 may each include a pair of spaced webs 44, 46 (best shown in FIG. 2), a brake table 48, and one or more brake linings 50.

Referring to FIG. 2, webs 44, 46 are provided to support brake table 48. Webs 44, 46 are axially spaced from each other and extend generally parallel to each other. Webs 44, 46 are semicircular in shape and may define semicircular recesses 52, 54 at either end. Recess 52 is configured to receive anchor 16 to enable pivotal motion of webs 44, 46 about an axis defined by anchor 16. Recess 54 is configured to receive one of cam followers 24, 26. Webs 44, 46 may also provide means, such as apertures 56, 58 for mounting retainer springs 22 and return springs 30.

Brake table 48 is provided to support brake linings 50 and is conventional in the art. Table 48 may be affixed to webs 44, 46 through welding, adhesives, or other fasteners. Table 48 is semicircular in cross-section and is substantially perpendicular to webs 44, 46.

Linings 50 are provided for frictional engagement with braking surface 40 of drum brake 12. Linings 50 may be made from conventional friction materials. It should be understood that the number, size and shape of linings 50 may vary.

Referring again to FIG. 1, retainer springs 22 are provided to retain brake shoes 18, 20—and particularly webs 44, 46—on anchor 16. Springs 22 are conventional in the art and the ends of springs 22 may be mounted to webs 44, 46 through apertures 56.

Cam followers 24, 26 provide a working surface for cam 28 to act against in order to move brake shoes 18, 20 between positions of engagement with and disengagement from braking surface 40 of drum brake 12. Cam followers 24, 26 may be received within recesses 54 in the webs 44, 46 of each brake shoe 18, 20. Cam followers 24, 26 are generally circular in shape.

Cam 28 is provided to cause movement of brake shoes 18, 20 between positions of engagement with and disengagement from brake shoes 18, 20. Cam 28 is disposed about an axis of rotation that may be generally parallel to the axis of rotation of drum brake 12 and/or the center axis of the axle. Referring again to FIG. 2, cam 28 is supported on and may be integral with camshaft 32 and is disposed at one axial end of cam shaft 52. Cam 28 comes in contact with cam followers 24, 26 which convert the rotary motion of cam 28 into linear motion.

Cam shaft 32 is provided to rotate cam 28 in order to engage and release the brake. Cam shaft 32 is conventional in the art and extends from cam tube 34. Rotational force may be provided to cam shaft 32 by an air brake actuator.

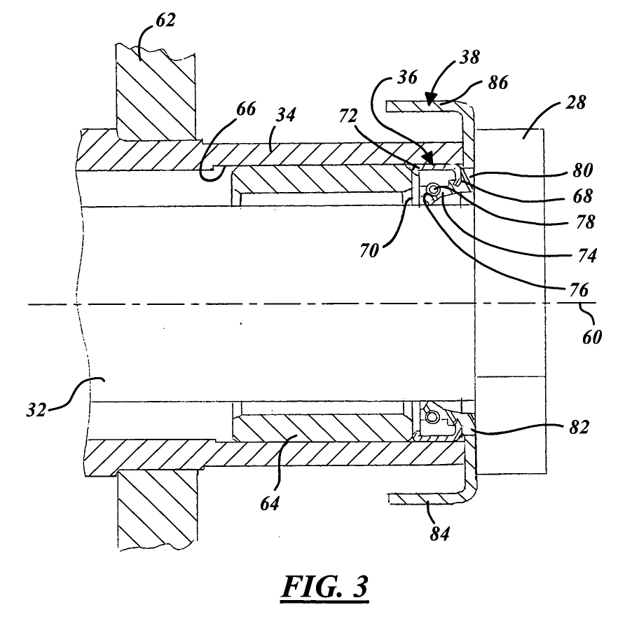

Cam tube 34 is provided to support cam shaft 32. Referring to FIG. 3, cam tube 34 is generally cylindrical in shape and is disposed about a longitudinal axis 60. Cam tube 34 may be supported on the vehicle by a mounting bracket 62, to which cam tube 34 may be fastened by welds or other conventional fasteners. Tube 34 may define a stepped diameter bore that is configured to receive a conventional bushing 64 allowing relative rotation of camshaft 32 and that is also configured to receive seal 36 at one axial end of tube 34.

Seal 36 is provided to retain lubricants within cam tube 34 and, in accordance with the present invention, is provided to restrict movement of cam washer 38. Seal 36 is disposed between cam shaft 32 and cam tube 34 and is disposed on an inner radial surface 66 of cam tube 34. Seal 36 is disposed proximate an outboard end of cam tube 34. Seal 36 is disposed about axis 60 and includes an axial outboard side 68 and an axial inboard side 70. Seal 36 includes an annular shell 72 that may be comprised of metal. Seal 36 further includes an elastomeric lip 74 coupled to annular shell 72. Elastomeric lip 74 may be bonded to the radially inner portion of annular shell 72. A radially outer portion of elastomeric lip 74 includes a notch 76 that may receive a spring 78. Spring 78 biases elastomeric lip 74 inward. Insertion of cam shaft 32 into cam tube 34 deflects elastomeric lip 74 against the force of spring 78 to create a tight seal.

In accordance with the present invention, seal 36 includes one or more lugs 80, 82 projecting from seal 36. Although two lugs 80, 82 are illustrated in FIGS. 2-3, it should be understood that a single lug or more than two lugs could be used. Lugs 80, 82 are diametrically opposite one another. Lugs 80, 82 may be made from an elastomeric material. Lugs 80, 82 may be made from the same material as lip 74 of seal 36 and may be integrally formed with lip 74. Further, the same elastomeric material or a different elastomeric material may be used to cover outboard side 68 of shell 72. Lugs 80, 82 project axially parallel to axis 60 and extend from outboard side 68 of seal 36. Lugs 80, 82 are formed with a thickness capable of withstanding vibration during operation of a vehicle and resisting laceration during the installation of the cam washer 38. Seal 36 is installed so as to orient lugs 80, 82 in a predetermined position in order to orient cam washer 38 is a predetermined position.

Referring again to FIG. 2, cam washer 38 is provided to maintain the components of drum brake assembly 10 in a predetermined position and prevent the brake shoes 18, 20 from interfering with fasteners in spider 14. Cam washer 38 is disposed about cam shaft 32 and separates cam 28 from the outboard end of cam tube 34. Cam washer 38 may be made from conventional metals and metal alloys and defines a pair of wings 84, 86 extending radially outwardly. Washer 38 defines a central aperture 88 sized to receive cam shaft 32 and defining an inner peripheral diameter 90. Washer 38 further defines a pair of notches 92, 94.

Notches 92, 94 are provided to receive lugs 80, 82 of seal 36. Notches 92, 94 are located on inner diameter 90 of washer 38. Although two notches 92, 94 are illustrated in FIG. 4 for receipt of corresponding lugs 80, 82, it should again be understood that a single lug and notch could be employed or more than two lugs and notches could be employed. Notches 92, 94 may be diametrically opposite one another. Lugs 80, 82 may engage notches 92, 94 in an interference fit to restrict movement of cam washer 38. Further, orienting seal 36—and therefore lugs 80, 82—in a predetermined position enables cam washer 38 to be placed in a predetermined position as well. The use of lugs 80, 82 and notches 92, 94 serve to isolate cam washer 38 from various vibration frequencies and from potential corrosion by contact with other metal components and surfaces.

A drum brake assembly in accordance with the present invention has many advantages as compared to various conventional drum brake assemblies. The inventive drum brake assembly provides at least one lug extending from a cam tube seal and corresponding notch on a cam washer that positions the cam washer and prevents excessive vibration of the cam washer. By reducing vibration of the cam washer, wear of the components of the drum brake assembly is reduced. Second, reduction of vibration serves to eliminate unpleasant noise during vehicle operation caused by the vibration. Third, reducing vibration of the cam washer decreases contact of the cam washer with other metallic components and surfaces within the vehicle, which protects the cam washer from potential corrosion caused by such contact.

While the invention has been particularly shown and described with reference to the preferred embodiments thereof, it is well known by those skilled in the art that various changes and modifications can be made in the invention without departing from the spirit and scope of the invention.

We claim:

1. A vehicle drum brake, comprising:
a cam tube disposed about an axis;
a seal disposed proximate an outboard end of said cam tube;
a cam shaft extending from said cam tube;
a cam mounted to said cam shaft;
a cam washer disposed between said cam tube and said cam; and
first and second brake shoes configured for selective engagement with a drum surface in response to rotation of said cam
wherein said seal includes a first lug projecting therefrom and said cam washer includes a first notch configured to receive said first lug.

2. The drum brake of claim 1 wherein said seal is disposed on an inner radial surface of said cam tube.

3. The drum brake of claim 1 wherein said first lug projects in the direction of said axis.

4. The drum brake of claim 1 wherein said seal is disposed so as to orient said first lug in a predetermined position.

5. The drum brake of claim 1 wherein said first lug comprises an elastomeric material.

6. The drum brake of claim 1 wherein said first lug extends from a first axial side of said seal.

7. The drum brake of claim 1 wherein said first lug extends from an outboard side of said seal.

8. The drum brake of claim 1 wherein said seal includes an annular metal shell and a lip made from an elastomeric material and coupled to said shell, said first lug made from said elastomeric material and integral with said lip.

9. The drum brake of claim 8 wherein said elastomeric material covers an outboard side of said shell.

10. The drum brake of claim 1 wherein said first notch of said cam washer is located on an inner diameter of said cam washer.

11. The drum brake of claim 1 wherein said first lug engages said first notch in an interference fit.

12. The drum brake of claim 1 wherein said first lug and said first notch are disposed so as to orient said cam washer in a predetermined position.

13. The drum brake of claim 1 wherein said first lug and said first notch restrict movement and rotation of said cam washer.

14. The drum brake of claim 1 wherein said seal includes a second lug projecting therefrom and said cam washer includes a second notch configured to receive said second lug.

15. The drum brake of claim 14 wherein said first lug and said second lug are diametrically opposite.
